(19) United States
(12) Patent Application Publication
(10) Pub. No.: US 2018/0334261 A1
(43) Pub. Date: Nov. 22, 2018

(54) TOUCH SCREEN TABLET PERSONAL COMPUTER HOLDER FOR A VEHICLE INCLUDING GENERAL AVIATION AIRCRAFT

(71) Applicant: Robert T. Longo, Arcadia, CA (US)

(72) Inventor: Robert T. Longo, Arcadia, CA (US)

(21) Appl. No.: 15/596,914

(22) Filed: May 16, 2017

(51) Int. Cl. B64D 43/00; A47B 88/48; F16B 1/00; B60R 11/02

(52) U.S. Cl. CPC B64D 43/00; A47B 88/48; F16B 2001/0035; B60R 11/0252; F16B 1/00

(57) ABSTRACT

A holder for a personal computer that is utilized in a vehicle. The holder includes a tray support device rigidly mounted to the vehicle framing. A tray is slidingly connected to the tray support device. A tilt device holds the tray at a downward tilt for improved viewing. When the holder is closed the tray is retained within the tray support device. When the holder is opened the tray is tilted downward and the tray is supported by the tilt device. In a preferred embodiment, the vehicle is an aircraft and the vehicle framing is aircraft instrument panel framing. In a preferred embodiment, the holder is installed within an avionics stack. Also, in a preferred embodiment the personal computer is a touch screen tablet personal computer.

The present invention relates to personal computer holders, and in particular, for personal computer holders within vehicle, including general aviation aircraft.

### BACKGROUND OF THE INVENTION

Touch screen tablet personal computers are known. The IPad and the IPad Mini (both trademarks of Apple Inc.) are both examples of a touch screen tablet personal computers. Apps are also known. An app is an abbreviated form of the word “application.” An application is a software program that's designed to perform a specific function directly for the user or, in some cases, for another application program. Several advanced navigational apps have been written for the IPad. These apps contain flight information superior to the information available on units costing many thousands of dollars more. These other units occupy excessive panel space in comparison to an IPad or an IPad Mini. The iPad system has been approved and is in use by many airlines. Additionally, the FAA now allows electronic maps to replace paper maps.

FIG. 1 shows a partial view of cockpit 1. Cockpit 1 includes gages 2 and avionics stack 3. Gages 2 and avionics stack 3 are in close proximity to the pilot so that he can have easy access to them during aircraft operation. Avionics 4 are stacked neatly in avionics stack 3. Common avionics 4 may include devices such as an aircraft radio, a digital audio-panel, an autopilot system, as well as other important devices.

Avionics 4 in avionics stack 3 are mounted inside cages 10 (FIG. 2). FIG. 2 shows instrument panel framing 11. Cages 10 are mounted to the instrument panel framing, as shown. Cages 10 allow for the easy insertion and mounting of avionics devices 4 to present a neat, flush appearance to the pilot as shown in FIG. 1.

There are various devices that are currently available to pilots that allow them to mount a touch screen tablet personal computer onto mounting device in the cockpit of the aircraft. However, these devices tend to be cumbersome, bulky and can take up space in the cockpit.

What is needed is a better device for mounting personal computers in an aircraft cockpit.

### SUMMARY OF THE INVENTION

The present invention provides a holder for a personal computer that is utilized in a vehicle. The holder includes a tray support device rigidly mounted to the vehicle framing. A tray is slidingly connected to the tray support device. A tilt device holds the tray at a downward tilt for improved viewing. When the holder is closed the tray is retained within the tray support device. When the holder is opened the tray is tilted downward and the tray is supported by the tilt device. In a preferred embodiment, the vehicle is an aircraft and the vehicle framing is aircraft instrument panel framing. In a preferred embodiment, the holder is installed within an avionics stack. Also, in a preferred embodiment the personal computer is a touch screen tablet personal computer.

### BRIEF DESCRIPTION OF THE DRAWINGS

FIG. 1 shows a prior art cockpit.

FIG. 2 shows prior art instrument panel framing and cages attached to the framing.

FIGS. 3-4 show a preferred embodiment of the present invention.

FIGS. 5-6 show s preferred base.

FIGS. 7-8 show s preferred tray.

FIGS. 9-11 show a preferred personal computer on a preferred tray.

FIGS. 12-13 show a preferred spring retention device.

FIGS. 14-19 show a preferred method for installing a holder.

FIGS. 20-23 show a preferred method for utilizing a holder.

FIGS. 24-32 show another preferred embodiment of the present invention.

FIGS. 33-35 show another preferred embodiment of the present invention.

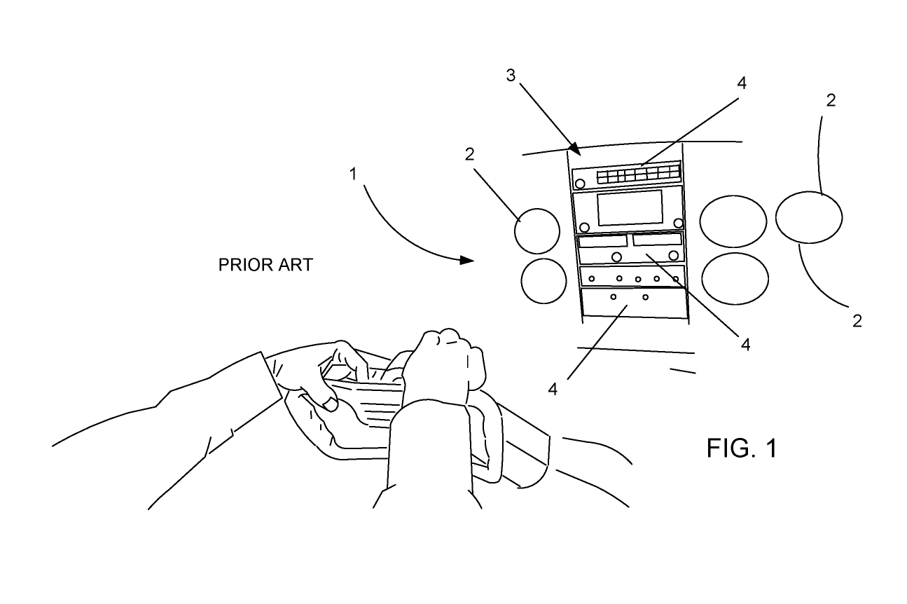

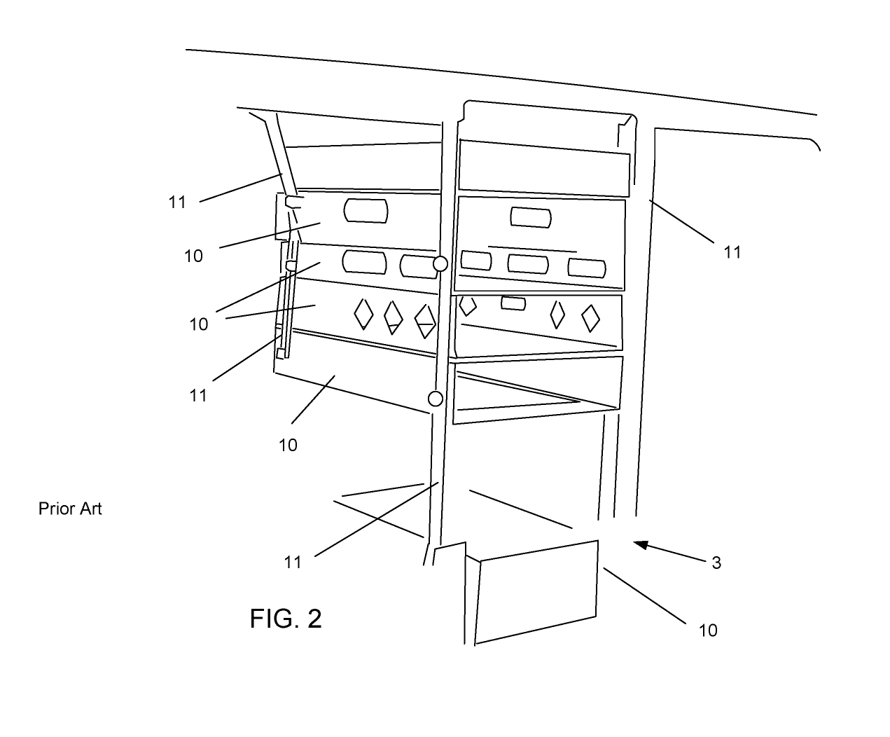

### DETAILED DESCRIPTION OF PREFERRED EMBODIMENTS OF THE PRESENT INNVENTION

### Overview

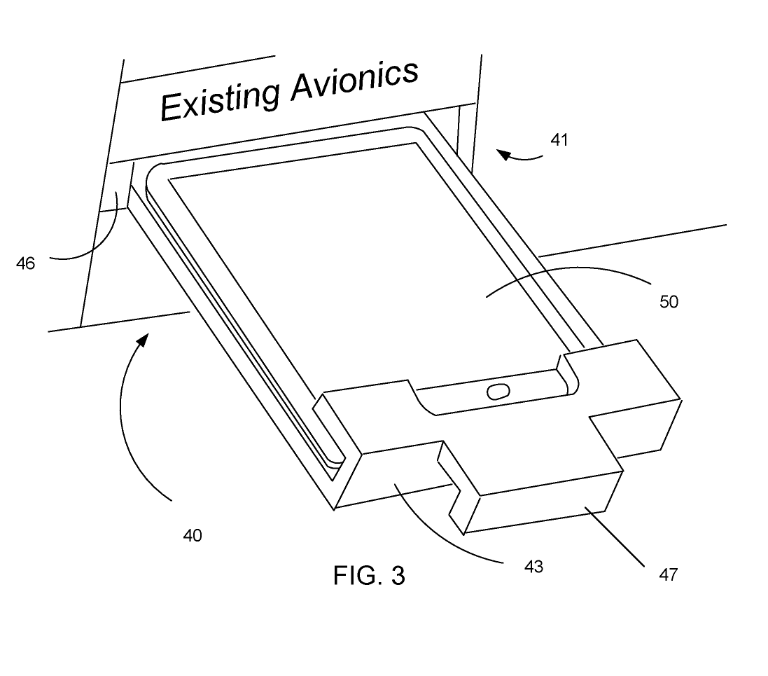

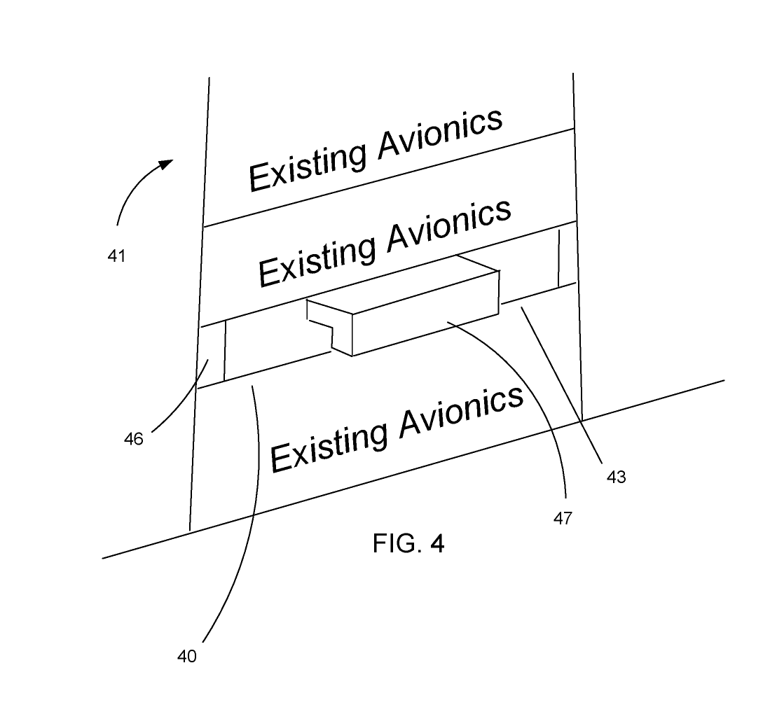

Holder 40 (FIG. 3) fits into avionics stack 41 and is approximately the same size as other avionics that fit within the stack, and takes up minimal space. It is retractable and can be closed simply by pushing it into avionic stack 41 during critical phases of flight, such as takeoff and landing or in emergencies so as not to distract the pilot. When needed the pilot simply pulls tray 43 and it hangs at a comfortable angle (for example a 30 degree angle) from the avionic stack for easy use. See also FIG. 23 showing tray 43 at angle of approximately 30 degrees).

Avionic items mounted below the holder can be accessed by closing tray 43. Touch screen personal computer 50 preferably always remains connected to aircraft cockpit power so that pilot does not need to worry that the touch screen personal computer will run out of battery power.

Also, as an additional safety feature, touch screen tablet personal computer 50 is battery operated and kept fully charged by the aircraft electrical system. Therefore, touch screen tablet personal computer 50 provides a backup electrical system for navigation if the aircraft electrical system fails.

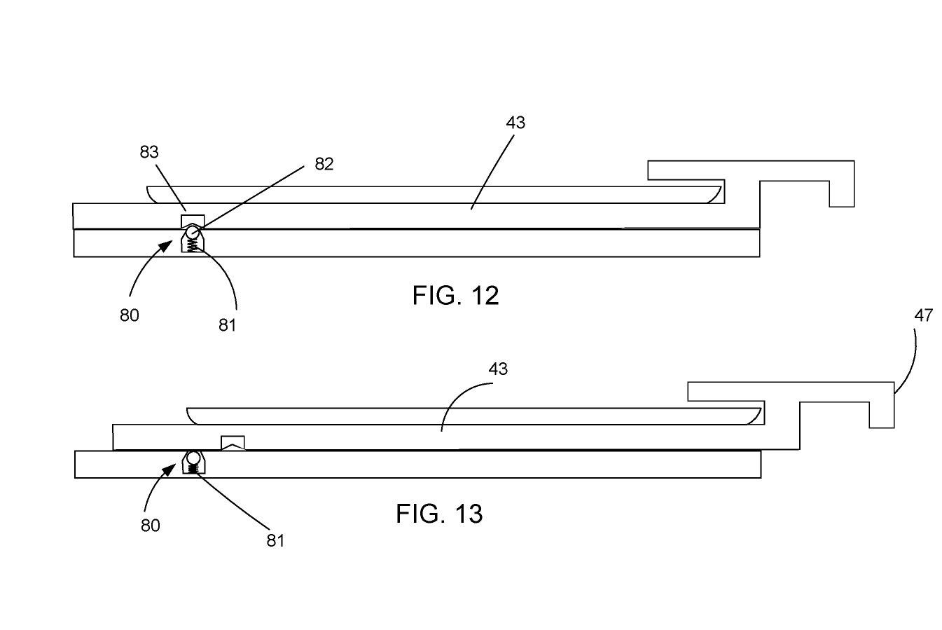

Holder 40 includes a fixed base 46 that does not move and is attached to a cage 10, and a tray 43 that holds touch screen tablet personal computer 50. Tray 43 functions like a drawer. When closed touch screen tablet personal computer 50 is not visible except for small handle 47 used for pulling it out. Tray 43 can be pulled out to a stop, from which it will hang at a comfortable 30 degree angle for pilot use. Base 46 and tray 43 utilize a spring loaded latch (see FIGS. 12-13) that can be overcome by simple pulling tray 43, but will keep the tray 43 closed during the acceleration of takeoff. As an alternative, magnets can be used in place of the spring loaded latch.

Touch screen tablet personal computer 50 can be easily removed from tray 43 for charging or preflight uses. It is simply lifted out of tray 43 when tray 43 is in the open position. During normal operation touch screen tablet personal computer 50 is captured by the tray and the avionic stack and held securely in tray 43 and will not come out during turbulence.

### The Base

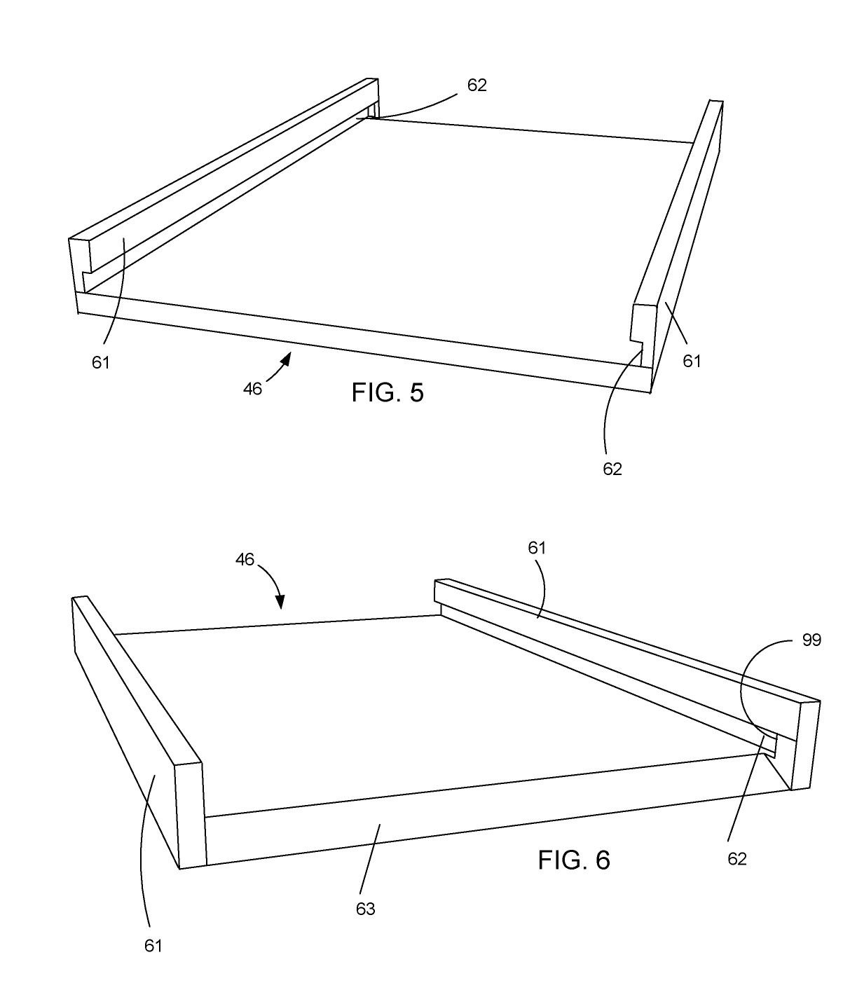

FIGS. 5 and 6 show perspective views of base 46. Base 46 includes side rails 61 each having a track 62. Track 62 ends at wall 99 prior to the front most edge of the base to prevent tray 43 from being pulled out accidentally. The front of base 46 includes base tilt edge 63.

### The Tray

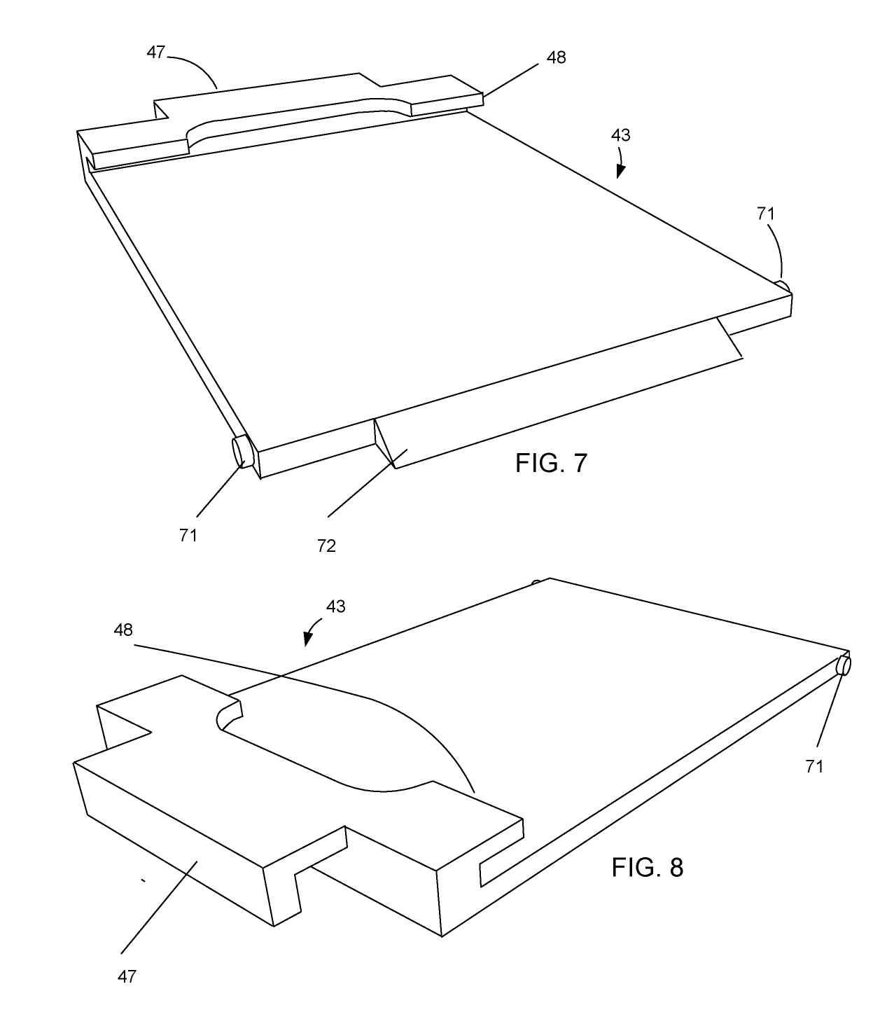

FIGS. 7 and 8 show perspective views of tray 43. Tray 43 includes handle 47 and overhang 48. Pins 71 are located towards the rear of tray 43 on each side of tray 43 as shown. The rear of tray 43 includes tray tilt edge 72.

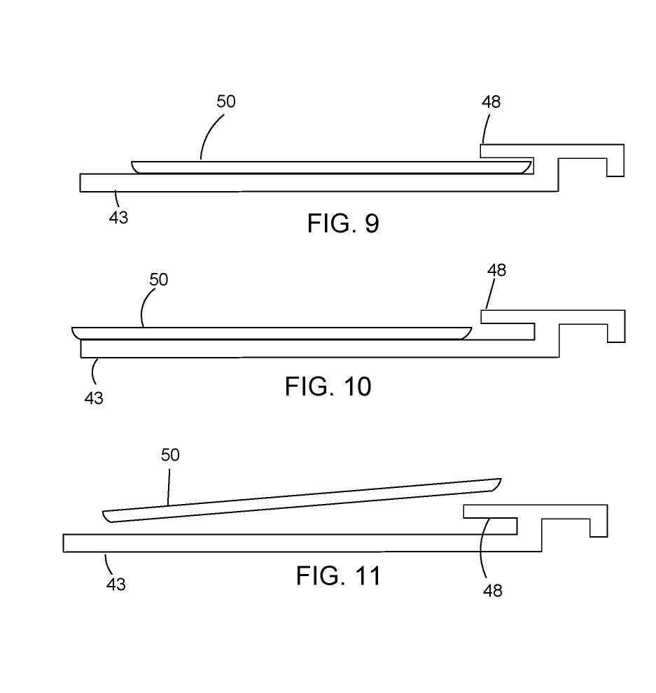

FIG. 9 shows tray 43 retaining touch screen tablet personal computer 50. Touch screen tablet personal computer 50 is slid under overhang 48. Overhang 40 holds touch screen tablet personal computer 50 in place and prevents it from falling out during operation.

FIGS. 10-11 show how a user can remove touch screen tablet from tray 43. In FIG. 10 the pilot has pushed touch screen tablet personal computer 50 towards the rear so that it is not under overhang 48. In FIG. 11 the pilot has begun to pull touch screen tablet person computer 50 away from tray 43 as shown.

FIGS. 12 and 13 depict the operation of retention spring device 80 for retaining tray 43 in a closed position so that it inadvertently does not open during motion of the aircraft. For example, in FIG. 12 tray 43 has been push closed. Spring 81 is pushing upward on ball 82 so that it engages insert 83, thereby preventing inadvertent motion of tray 43. In FIG. 13 the pilot has pulled on handle 47. The force applied by the pulling motion easily overcomes the force applied by spring 81 and tray 43 is able to be pulled outwards as shown.

It should be further noted that in another preferred embodiment magnets can be used in place of retention spring device 80. The magnets would operate to hold tray 43 closed during times of high acceleration, such as takeoff. The force applied by the pulling motion of a pilot would easily overcome the magnetic forces so that tray 43 is able to be pulled outwards as shown.

### Insertion and Utilization of the Holder

As stated above, in a preferred embodiment holder 40 is installed into a cage 10 that has been mounted onto instrument panel framing 11 to become part of avionics stack 3.

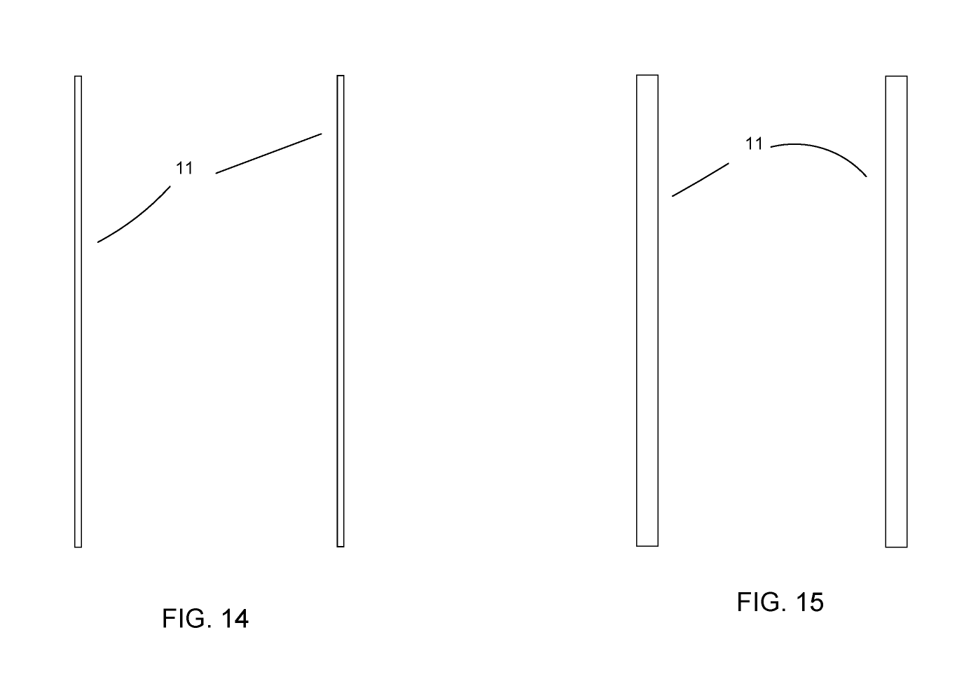

FIGS. 14-19 depict one example of steps associated with installation of holder 40.

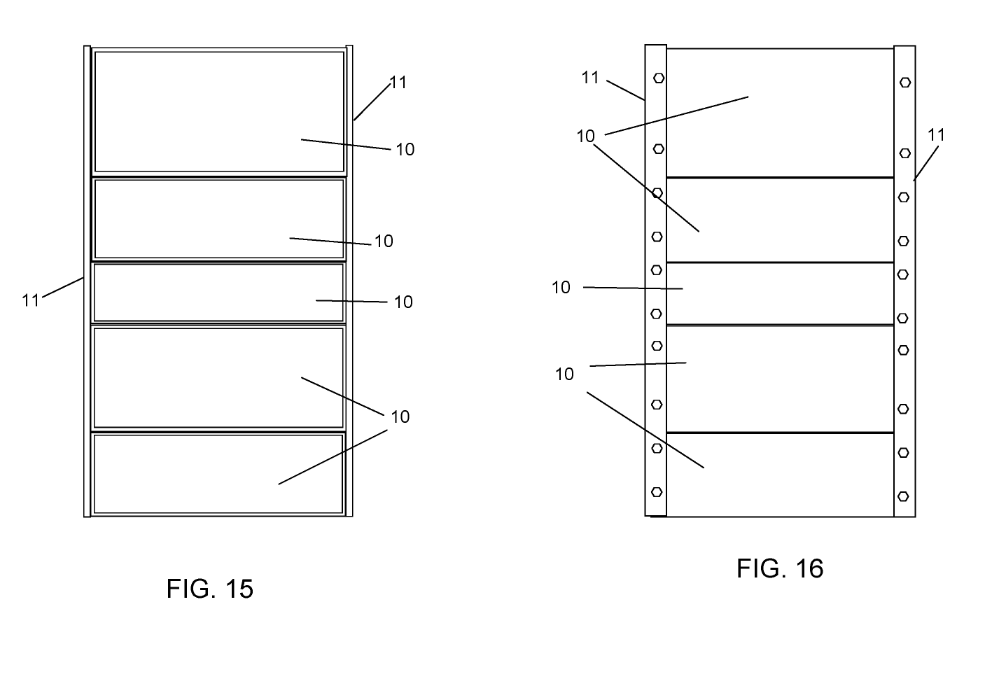

FIG. 14 shows a front view of framing 11 and FIG. 15 shows a side view of framing 11.

In FIGS. 15-16 cages 10 have been mounted to framing 11.

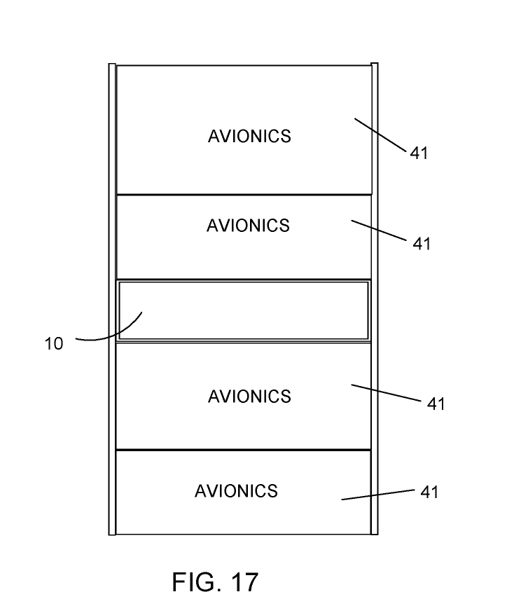

In FIG. 17, avionics 14 have been mounted inside cages 10 of framing 11. The middle cage 10 is still empty.

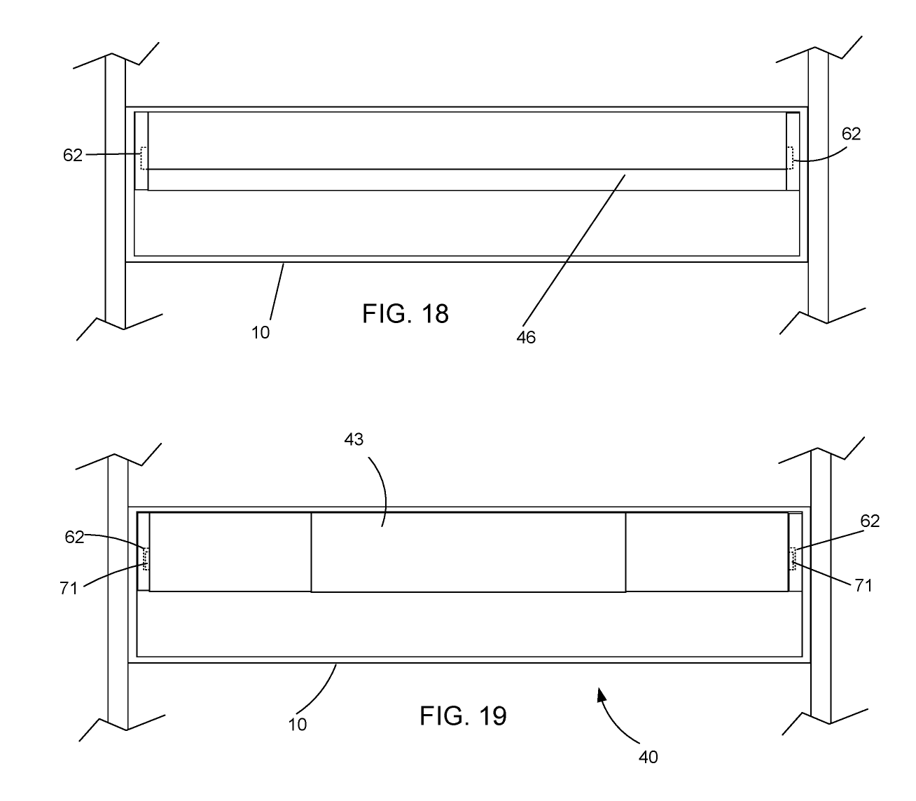

In FIG. 18, base 46 has been rigidly mounted to middle cage 10.

In FIG. 19, tray 43 has been slid into base 46. Pins 71 ride smoothly in tracks 62. Holder 40 is now installed.

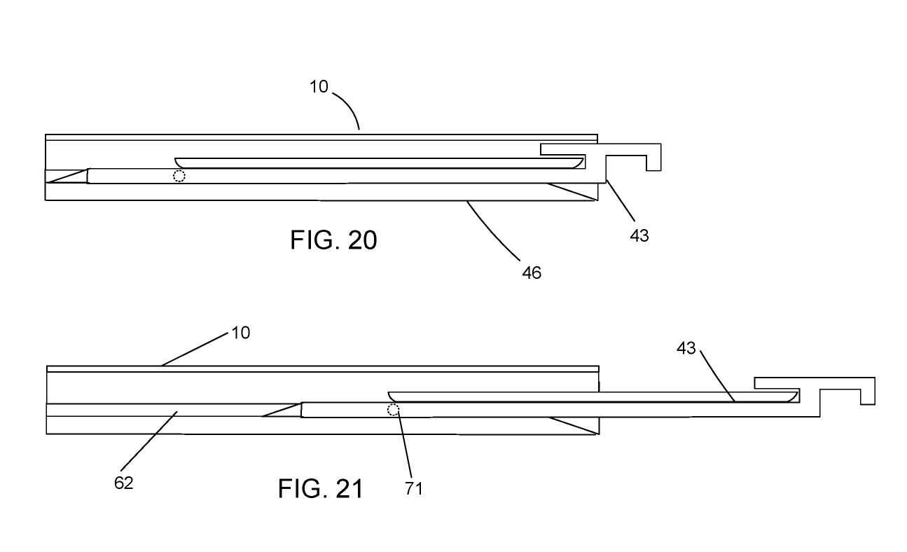

FIGS. 20-23 show the utilization of holder 40.

In FIG. 20, tray 43 is inserted inside cage 10 and is resting on base 46.

In FIG. 21, the pilot has pulled on tray 43 and tray 43 is sliding out of cage 10. Pins 71 are sliding smoothly in tracks 62.

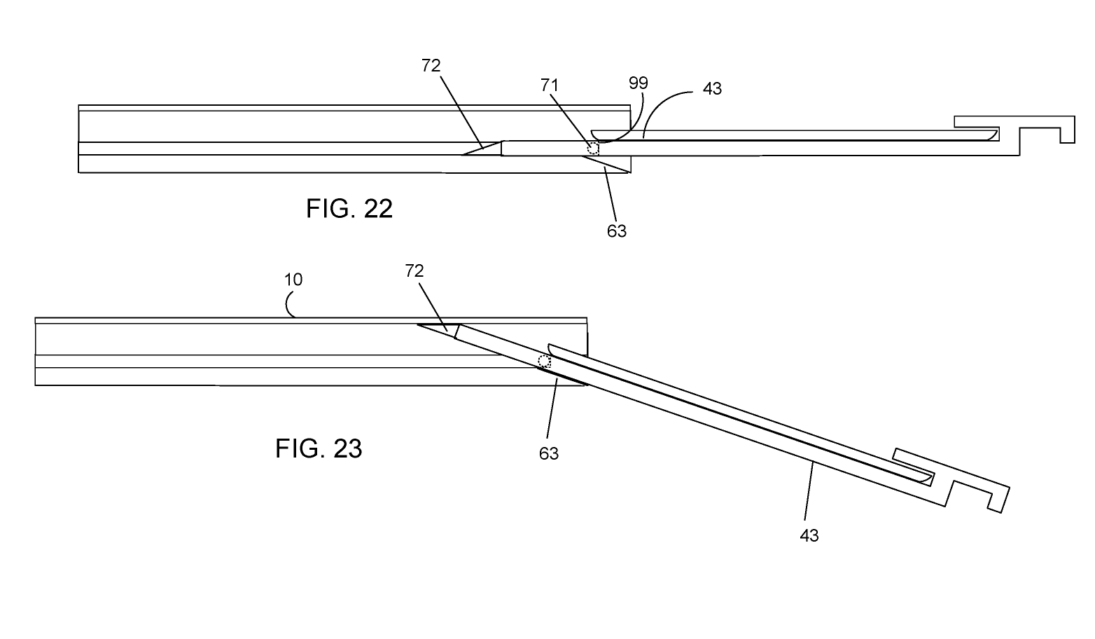

In FIG. 22, the pilot has pulled tray 43 so pin 71 has been stopped by wall 99 (see also FIG. 6).

In FIG. 23, the pilot has let go of tray 43 so that tray 43 tilts and is supported by base tilt edge 63 and tray tilt edge 72, with tray 43 resting on base tilt edge 63 and tray tilt edge 72 pressing upwards on the bottom of cage 10. Touch screen tablet personal computer 50 is now presented at approximately a 30 degree angle to the pilot for comfortable viewing. Additionally, personal computer 50 has been lowered to level below the level of base 46. When the pilot no longer needs to view touch screen personal computer 50, he can push tray 43 back inside cage 10 so that it is in the position shown in FIG. 20.

### Other Preferred Embodiment

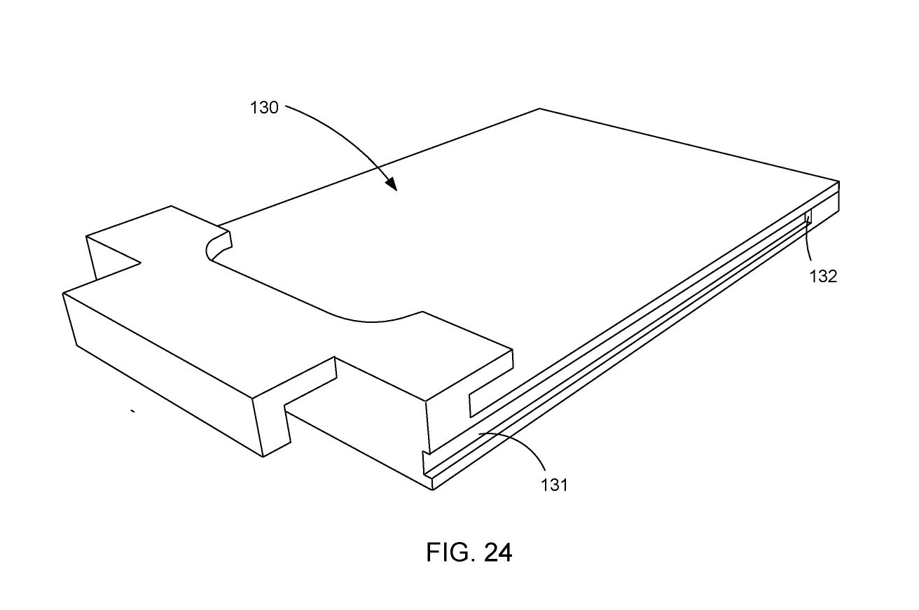

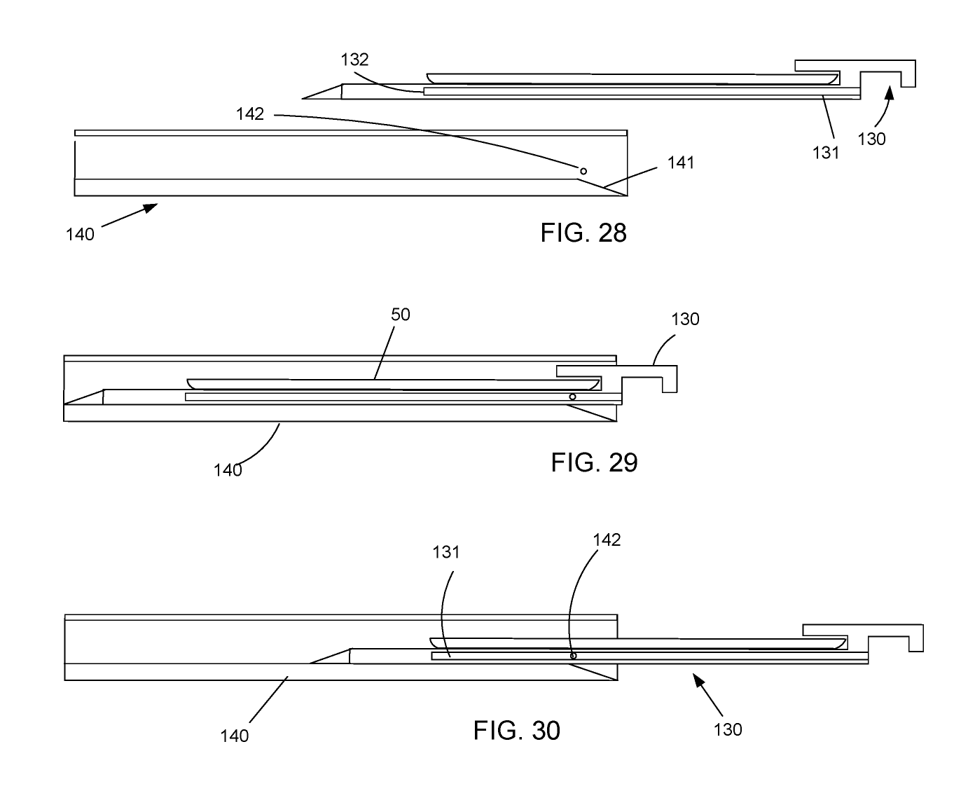

FIGS. 24-32 show another preferred embodiment of the present invention. This preferred embodiment utilizes tray 130 having track 131 with stop 132 (FIG. 24 and FIG. 28). Also, cage 140 is utilized having cage tilt edge 141 and pin 142. By utilization of tray 130 with cage 140, the user can avoid having to install a separate base, such as base 46 described above.

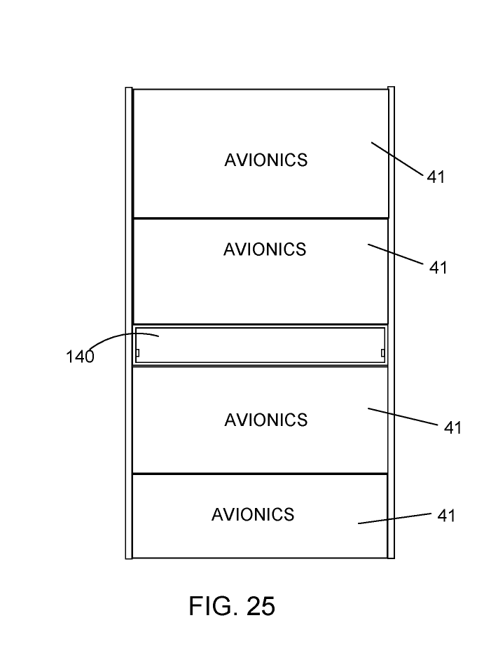

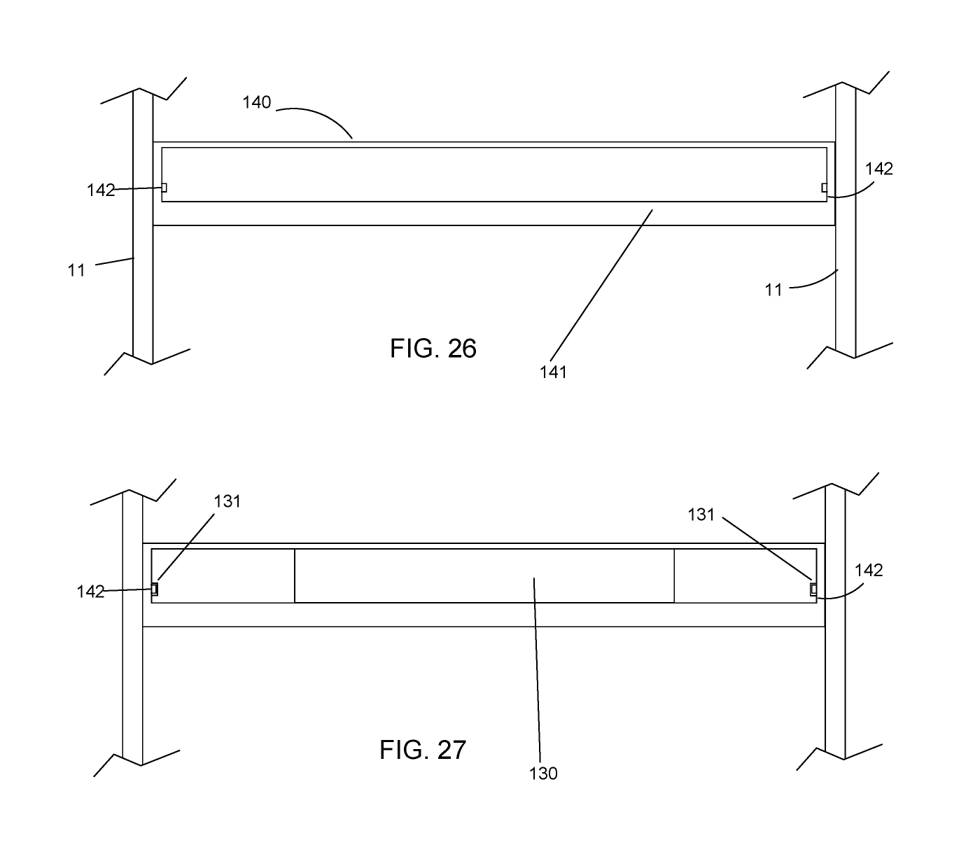

For example, in FIG. 25 cage 140 has been rigidly connected to framing 11 between avionics devices 41, as shown. FIG. 26 shows a close up view of cage 140 bolted to framing 11. Pins 142 are rigidly connected to the sides of cage 140 as shown.

In FIG. 27, tray 130 has been inserted into cage 140. Track 131 runs smoothly along pins 142.

FIG. 29 shows a side view of the image shown in FIG. 27. Tray 130 is fully inserted into cage 140. Touch screen tablet personal computer 50 is contained fully in cage 140.

In FIG. 30, the pilot has pulled on tray 130 and tray 130 is sliding out of cage 140. Tracks 131 run smoothly along pins 142.

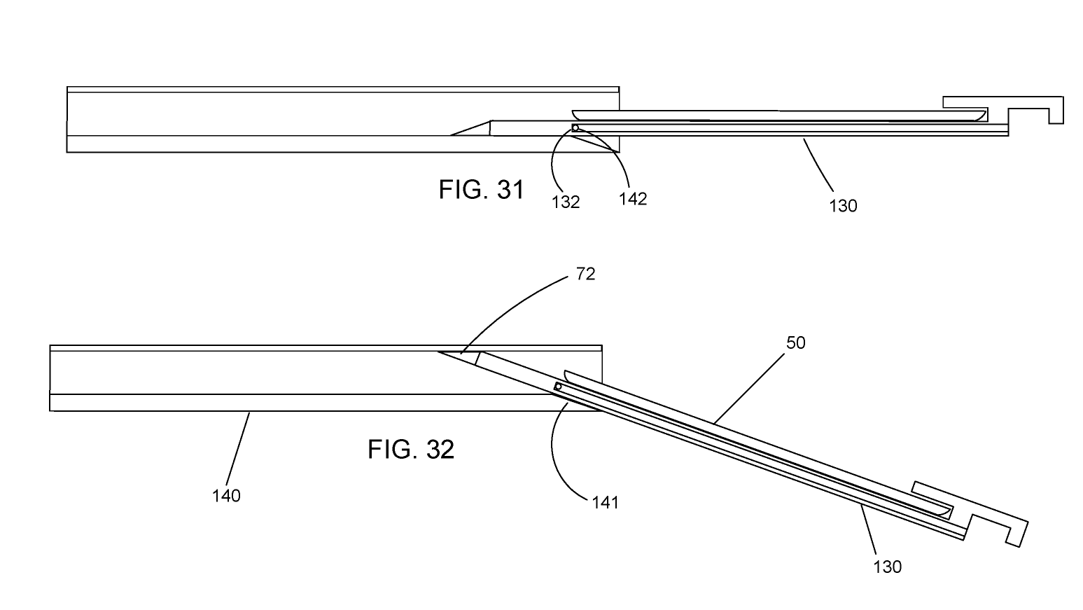

In FIG. 31, the pilot has pulled tray 130 so track stop 132 has been stopped by pin 142.

In FIG. 32, the pilot has let go of tray 130 so that tray 130 tilts and is supported by cage tilt edge 141 and tray tilt edge 72, with tray 130 resting on cage tilt edge 141 and tray tilt edge 72 pressing upwards on the bottom of cage 140. Touch screen tablet personal computer 50 is now presented at approximately a 30 degree angle to the pilot for comfortable viewing. Additionally, personal computer 50 has been lowered to level below the level of cage 140. When the pilot no longer needs to view touch screen personal computer 50, he can push tray 130 back inside cage 140 so that it is in the position shown in FIG. 29.

### Other Preferred Embodiment

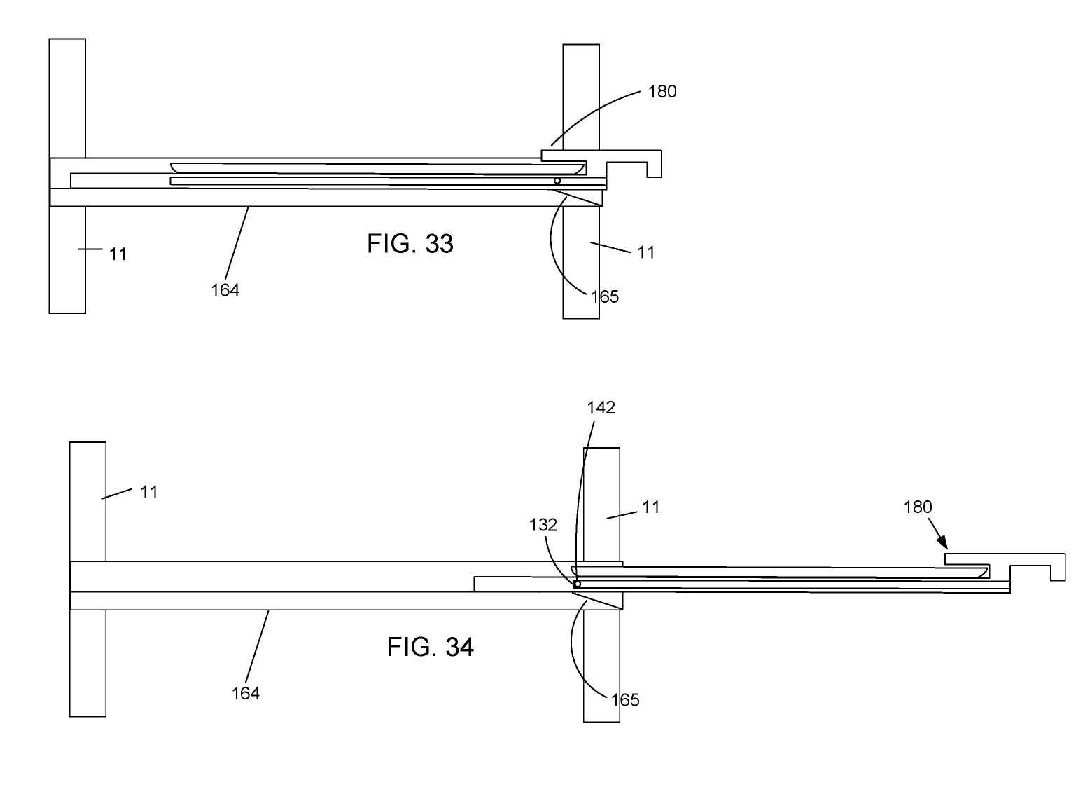

FIGS. 33-35 show another preferred embodiment of the present invention. This embodiment shows base 164 attached directly to framing 11 without the utilization of a cage. Also there is not utilization of a tray tilt edge. Base tilt edge 165 is sufficient to hold the tilt.

In FIG. 33 tray 180 has been pushed back into base 164 in the closed position.

In FIG. 34, the pilot has pulled tray 180 so track stop 132 has been stopped by pin 142.

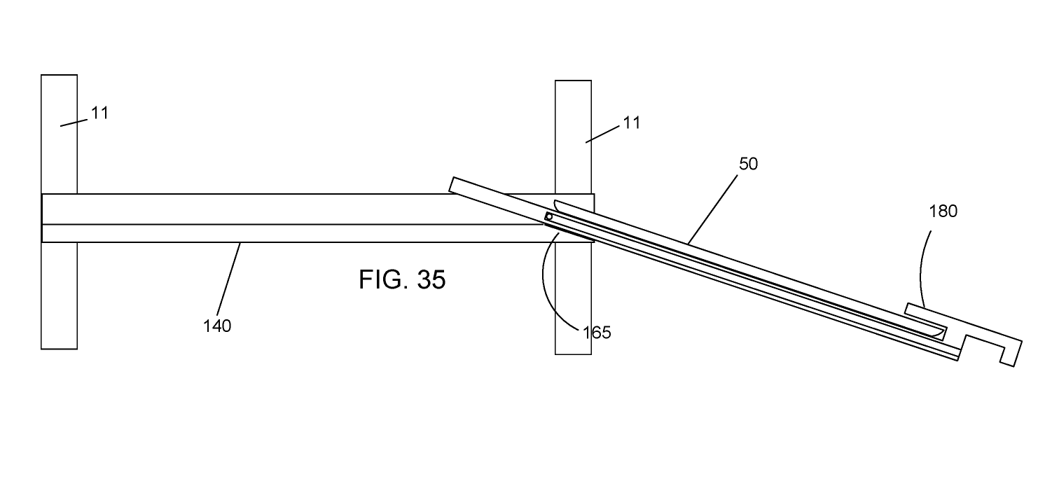

In FIG. 35, the pilot has let go of tray 180 so that tray 180 tilts and is supported by base tilt edge 165, with tray 180 resting on base tilt edge 165. Touch screen tablet personal computer 50 is now presented at approximately a 30 degree angle to the pilot for comfortable viewing. Additionally, personal computer 50 has been lowered to level below the level of base 164. When the pilot no longer needs to view touch screen personal computer 50, he can push tray 180 back into base 164 so that it is in the position shown in FIG. 33.

### Rigidly Mounted Tray Support Mounts

It should be noted that the above discussions of bases and cages (for example, base 164, cage 140 and base 46) are each examples of tray support devices that are rigidly mounted to framing 11. The rigidly mounted tray support devices each allow for the sliding and storage of trays and for the tilted presentation of touch screen tablet personal computer 50.

Although the above-preferred embodiments have been described with specificity, persons skilled in this art will recognize that many changes to the specific embodiments disclosed above could be made without departing from the spirit of the invention. For example, even though the above embodiments discussed the utilization of the preferred embodiments in an aircraft and attached to aircraft instrument panel framing, it should be understood that the above preferred embodiments could be utilized in any vehicle type, including a car, boat, or train. The tray support device would be rigidly attached to the vehicle framing in a fashion similar to that described above and the tray would slide in and out and tilt in a fashion similar to that described above. Also, even though the above preferred embodiments discussed the utilization of holder 40 with a touch screen tablet personal computer 50, it should be understood that holder 40 could be utilized to support other types of personal computers. For example, holder 40 could be used to support a smart phone or a laptop computer. Therefore, the attached claims and their legal equivalents should determine the scope of the invention.

What is Claimed is:

1) A holder for a personal computer in a vehicle, said holder for mounting to said vehicle framing, said holder comprising:
A. a tray support device rigidly mounted to said framing,
B. a tray slidingly connected to said tray support device,
C. a tilt device for holding said tray at a downward tilt when said holder is opened,
wherein when said holder is closed, said tray is retained within said tray support device, and when said holder is opened said tray is tilted downward and said tray is supported by said at least one tilt device.

2) The holder as in claim 1, wherein said vehicle is an aircraft and said vehicle framing is aircraft instrument panel framing.

3) The holder as in claim 1 wherein said tilt device is at least one tilt edge connected to either said tray support device or said tray.

4) The holder as in claim 1, wherein said tray support device is a cage, said cage having cage sides and comprising a plurality of pins connected to said cage sides, said tray having a tray front end and a tray rear end and tray sides, said tray comprising:
A. a handle at said try front end,
B. an overhang connected to said tray and for covering said personal computer,
C. a tray track along each said tray side and engaged with said cage pins.

5) The holder as in claim 1, wherein said tray support device is a base rigidly connected to said framing, said base having a base front end and comprising:
A. two side rails,
B. a track in each side rail, said track having a track front end,
C. a pin wall located at said track front end,
D. a base tilt edge located at said base front end,
wherein said tray is slidingly connected to said base, said tray having a tray front end and tray rear end, said tray comprising:
A. a handle at said tray front end
B. an overhang connected to said tray and for covering said personal computer,
C. a plurality of pins connected to said tray and for sliding in said tracks,
D. a tray tilt edge connected to said tray rear end.

6) A holder for a personal computer in a vehicle, said holder for mounting to said vehicle framing, said holder comprising:
A. a base rigidly connected to said framing, said base having a base front end and comprising:
a. two side rails,
b. a track in each side rail, said track having a track front end,
c. a pin wall located at said track front end,
d. a base tilt edge located at said base front end,
B. a tray slidingly connected to said base, said tray having a tray front end and tray rear end, said tray comprising:
a. a handle at said tray front end
b. an overhang connected to said tray and for covering said personal computer,
c. a plurality of pins connected to said tray and for sliding in said tracks,
d. a tray tilt edge connected to said tray rear end.

7) The holder as in claim 6, wherein said vehicle is an aircraft and said vehicle framing is aircraft instrument panel framing.

8) The holder as in claim 1, wherein said holder is inserted into an avionics stack.

9) The holder as in claim 1, wherein said personal computer is a touch screen tablet personal computer.

10) The holder as in claim 1, further comprising a retention device for retaining said tray inside said cage during operation of said aircraft.

11) The holder as in claim 10, wherein said retention device is a magnetic retention device.

12) The holder as in claim 9, wherein said retention device is a spring retention device.

13) The holder as in claim 1, wherein said personal computer is connected to aircraft cockpit power while resting on said holder.

14) A holder for a personal computer in vehicle, said holder for mounting to an framing, said holder comprising:
A. a cage mounted to said framing, said cage having cage sides and comprising at least one pin connected to each cage side,
B. a tray slidingly connected to said cage, said tray having tray sides and comprising a track one each tray side, said tray track engaged with said cage pins for said sliding connection
C. a tilt device for holding said tray at a downward tilt,
wherein when said holder is closed, said tray is retained within said cage, and when said holder is opened said tray is tilted downward and said tray is supported by said at least one tilt edge.

15) The holder as in claim 14, wherein said vehicle is an aircraft and said vehicle framing is aircraft instrument panel framing.

16) The holder as in claim 14 wherein said tilt device is a tray tilt edge pressing upwards on said cage.

17) The holder as in claim 14, wherein said tilt device is a cage tilt edge supporting said tray.

18) The holder as in claim 14 wherein said tilt device is a tray tilt edge pressing upwards on said cage and a cage tilt edge supporting said tray.

19) The holder as in claim 1, wherein said tray support device is a cage.

20) The holder as in claim 1, wherein said tray support device is a base.
